(19) United States
(12) Patent Application Publication
(10) Pub. No.: US 2002/0069139 A1
(43) Pub. Date: Jun. 6, 2002

(54) Method of conducting transactions using a distributed computer network such as the internet

(76) Inventors: Jared Bernstein, London (GB); Caroline Green, Lambourn (GB); Joseph Haim, London (GB); Sherril McCahon, Comber (GB); Gareth Creaney, Crumlin (GB); Gary Wotherspoon, Magherafelt (GB)

Correspondence Address: LUEDEKA, NEELY & GRAHAM, P.C., P O BOX 1871, KNOXVILLE, TN, 37901, US

(21) Appl. No.: 09/970,391

(22) Filed: Oct. 3, 2001

(30) Foreign Application Priority Data
Oct. 4, 2000 (GB) 0024302.2

(51) Int. Cl. G06F 17/60

(52) U.S. Cl. 705/27

(57) ABSTRACT

In the method of the present invention a purchaser of goods uses a client computer to order goods from a site hosted by a host computer. The host computer is linked to a payment processing computer. In the method the host computer sends to the payment processing computer an identifier identifying a classification of the ordered goods. The client computer also sends an identifier to the payment processor computer. The payment processor compares the identifiers to determine whether the purchaser is authorised to purchase the ordered goods having regard to the classification of the goods.

1. Field of the Invention

The present invention relates to a method of conducting transactions using a distributed computer network, such as the Internet.

2. Background of the Invention

Typically at present when purchases are made online from websites on the Internet, credit cards are used. This excludes many potential buyers of goods and services, who do not have credit cards. For instance, most children do not have credit cards. The present invention seeks to provide a solution to this, whilst at the same time ensuring that e.g. children are prevented from purchasing inappropriate goods and/or services on-line.

### SUMMARY OF THE INVENTION

The present invention provides a method of conducting transactions using a distributed computer network such as the Internet, the method comprising:

a purchaser of goods and/or services using client computer apparatus to access via a telecommunications network host computer apparatus which hosts a publicly accessible site of a vendor which advertises for sale goods and/or services;

the purchaser using the client computer apparatus to send electronically via the telecommunications network to the host apparatus an order for advertised goods and/or services;

the host computer linking the client computer apparatus via the telecommunications network with payment processing apparatus;

a payment administrator storing in a database of the payment processing apparatus records of a plurality of debit identifiers and a plurality of stored value accounts, each debit identifier being linked with a single stored value account;

the purchaser using the client computer apparatus to send to the payment processing apparatus a debit identifier with authorisation to debit from the stored value account associated with the debit identifier a sum for purchase of the ordered goods and/or services; and

the payment processing apparatus after receipt of the debit identifier debiting the stored value account linked thereto and transferring electronically payment for the ordered goods and services to an account of or nominated by the vendor;

characterised in that:

the host computer apparatus sends to the payment processing apparatus identification information from which the payment processing apparatus can determine a classification of the ordered goods and/or services;

the payment processing apparatus stores for each debit identifier permission information detailing which classifications of goods and/or services can be purchased; and

the payment processing apparatus accepts an authorisation to debit value from the stored value account associated with the debit identifier only when the identification information received from the host computer indicates that the ordered goods and/or services have a classification which matches a classification in the permission information stored for the debit identifier.

The present invention solves the problem of e.g. children purchasing inappropriate goods and services from websites by ensuring the classification information is considered at the time of authorisation for payment and refusing to accept payment when it is clear that there is no permission to purchase certain goods and services. For instance, a parent could obtain for a child a debit identifier to enable the child to purchase toys on-line, whilst being safe in the knowledge that if the child tries to, for instance, place a bet on an adult website that such a purchase will not be processed.

Preferably in the method a plurality of vendors advertise for sale goods and/or services via a plurality of sites hosted on a plurality of host computer apparatus all connected to the telecommunications network. Preferably a plurality of purchasers use a plurality of client computer apparatus to access the telecommunications network and to send orders for goods and/or services via the telecommunications network to the plurality of host apparatus. Preferably the method additionally comprises the steps of classifying each publicly accessible site having regard to the goods/services offered thereby; the host computer sending to the payment processing means information regarding classification of the publicly accessible site from which the goods/services are ordered; and the payment processing apparatus determining whether there is permission to order any goods/services from the publicly accessible site of the vendor.

In this aspect of the invention, each individual website is classified. Therefore, an adult website offering for sale, e.g. betting and gaming services can be suitably classified so that a minor cannot purchase any services (including downloads) from such a site.

In a further aspect of the invention the method again comprises a plurality of vendors advertising for sale goods and/or services via a plurality of sites hosted on a plurality of host computer apparatus all connected to the telecommunications network. Again, a plurality of purchasers use a plurality of client computer apparatus to access the telecommunications network and send orders for goods and/or services via the telecommunications network to a plurality of host apparatus. In this further aspect the method additionally comprises the steps of classifying every good and/or service offered for sale by a vendor on a publicly accessible site thereof; the host computer sending to the payment processing apparatus classification information regarding the individually ordered goods and/or services; and the payment processing apparatus determining from the stored permission information for individual goods and/or services whether there is permission to order such goods and/or services.

In this aspect the invention copes with e.g. sites offering for sale books and videos. The site may offer for sale childrens' books and childrens' videos and also adult books and adult videos. In the method each video and book would be classified and when an order is placed the payment processing apparatus would determine whether each ordered book or video can be properly purchased by the purchaser. Thus again an adult can obtain a debit identifier for his or her child, (e.g., by buying a card) which the child can use to purchase books and videos whilst the adult is secure in the knowledge that the child will not be able to purchase books or videos classified for adult purchase.

Preferably the method comprises the steps of:

a purchaser purchasing from a retailer a card bearing a debit identifier;

the retailer collecting payment for the card from the purchaser; and

the purchaser subsequently using the debit identifier on the purchased card to authorise debiting from the stored value account associated with the debit identifier.

In this aspect of the invention there are also advantages of increased security. An adult cannot obtain a credit card for a child, (i.e., someone under the age of 16), but may be happy to purchase for a given value a card which a child can then use for purchases on the Internet. For instance, a $10.00 value card can be purchased by an adult for a child as a gift and the child can then buy goods and services up to a limit value of $10.00. This also has benefits for on-line retailers, because the retailers will have knowledge that the purchaser has already deposited money with an independent administrator and therefore there will be funds available for the purchase. This certainty is not available with credit cards, when the purchasers may exceed their spending limit.

It is envisaged that three different types of card will be available, a Red card intended for sale to adults and having a debit identifier linked to a fullest set of permissions; a Yellow card intended for sale to those over 16 years of age and having a debit identifier linked to a limited set of permissions; and a Green card intended for sale to anybody, no matter what age and having an identifier linked to a most restricted set of permissions. It is envisaged that adults will be able to buy on-line Green and Yellow cards (but not Red) using e.g. credit cards. On the high street, newsagents will sell only Green and Yellow cards and will only sell Yellow cards to those over sixteen years of age. Red cards will be available only in establishments for adults e.g. licensed premises and betting shops.

Preferably the debit identifier borne by the card has a removable layer and the method comprises the step of the purchaser removing the removable layer to reveal the debit identifier.

In the preferred method the cards are “scratch cards” having debit identifiers, e.g in the form of numbers, concealed by a scratch-off layer which is scratched off after purchase of the card to enable a purchaser to subsequently make use of the card in online transactions.

Preferably in the method the retailer will purchase from the administrator batches of cards bearing debit identifiers and the retailer will communicate with the administrator to confirm receipt of each batch of cards and the administrator will activate a debit identifier only after receiving confirmation of receipt by the retailer of a card associated with the debit identifier. The administrator will refuse to authorise debiting of a stored value account until the debit identifier associated therewith has been activated. This feature of the invention gives an added degree of security, because if cards go missing between the administrator and the retailer then they will be useless because they will not be activated by the retailer.

Preferably each card has indicator means indicating which classification of goods and services can be purchased using the cards and preferably a purchaser will select a card for purchase having regard to the indicator means. Typically, the indicator means will be colour of the card and there may be for instance three different colours of card, one colour card giving permission for the purchase of every kind of goods and services, the second colour card giving permission for a reduced range of goods and services and the third colour card giving permission for the most limited range of goods and services.

Preferably the retailer will sell cards with certain indicator means only to purchasers above an age threshold. In the same way that retailers are used to controlling the sale of alcohol, cigarettes and gambling cards, e.g. Lottery cards, the retailers can control the sale of the cards bearing debit identifiers so that minors are only ever sold cards which have debit identifiers associated with suitable limited permissions. As mentioned above it is envisaged that high street retailers such as newsagents will only be allowed to sell Green and Yellow cards. Sale of Red cards will be restricted to licensed outlets such as betting shops. Furthermore, it will be possible to purchase debit identifiers online and it is envisaged that the debit identifiers issued on-line will have permissions equivalent to those of Green and Yellow cards.

Preferably each card when purchased has a debit identifier which has associated therewith a stored value account containing a predetermined level of stored value ascertainable by a purchaser prior to purchase; and different cards bear identifiers associated with the stored value accounts of different values.

It is envisaged that there will be available for purchase cards for different denominations of e.g. $1.00, $5.00, $10.00, $20.00 etc.

Further aspects of the present invention concern use of a personal computer as client computer apparatus in methods described above, use of a computer as host computer apparatus in the methods as described above, use of a computer server as payment processing apparatus in the methods described above and use of a card bearing a debit identifier in methods as described above.

### BRIEF DESCRIPTION OF THE DRAWINGS

Preferred embodiments of the present invention will now be described with reference to the drawings, in which:

FIG. 1 is a schematic diagram showing a distributed computer network implementing the method of the present invention;

FIG. 2 is a schematic diagram showing a card for use in the method of the present invention with a graphical flow diagram illustrating security features of the card;

FIG. 3 is an illustration of one example of a first screen seen by a purchaser purchasing goods and/or services by a method of the present invention; and

FIG. 4 is an illustration of one example of a second screen seen by a purchaser purchasing goods and/or services by a method according to the present invention.

### DETAILED DESCRIPTION OF THE PREFERRED EMBODIMENT(S)

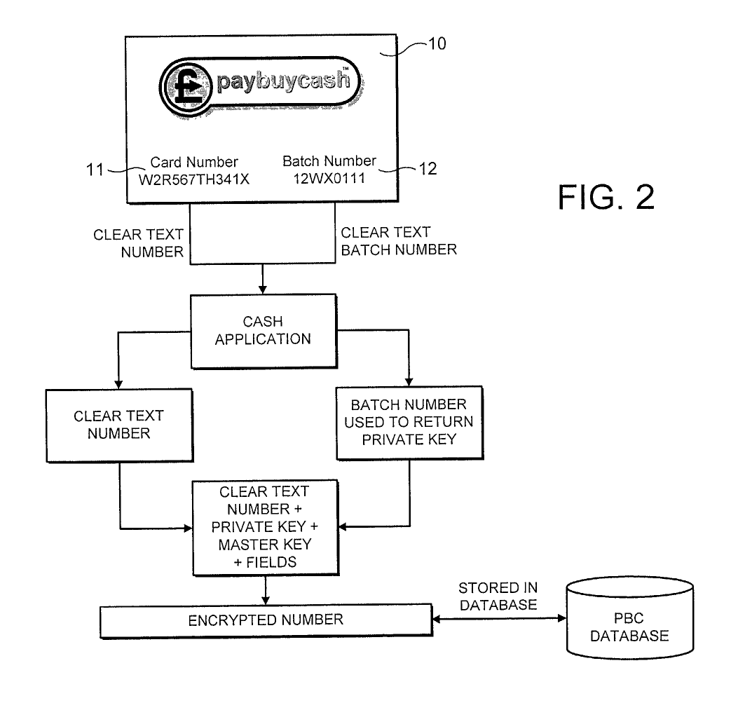

In the preferred embodiment of the present invention purchasers of goods and services on-line first buy a card from a high street retailer such as the card 10 shown in FIG. 2. The card 10 will be a scratch card, with two separate scratch panels which will be scratched off by the purchaser to reveal a unique secure card number 11 and a batch number 12.

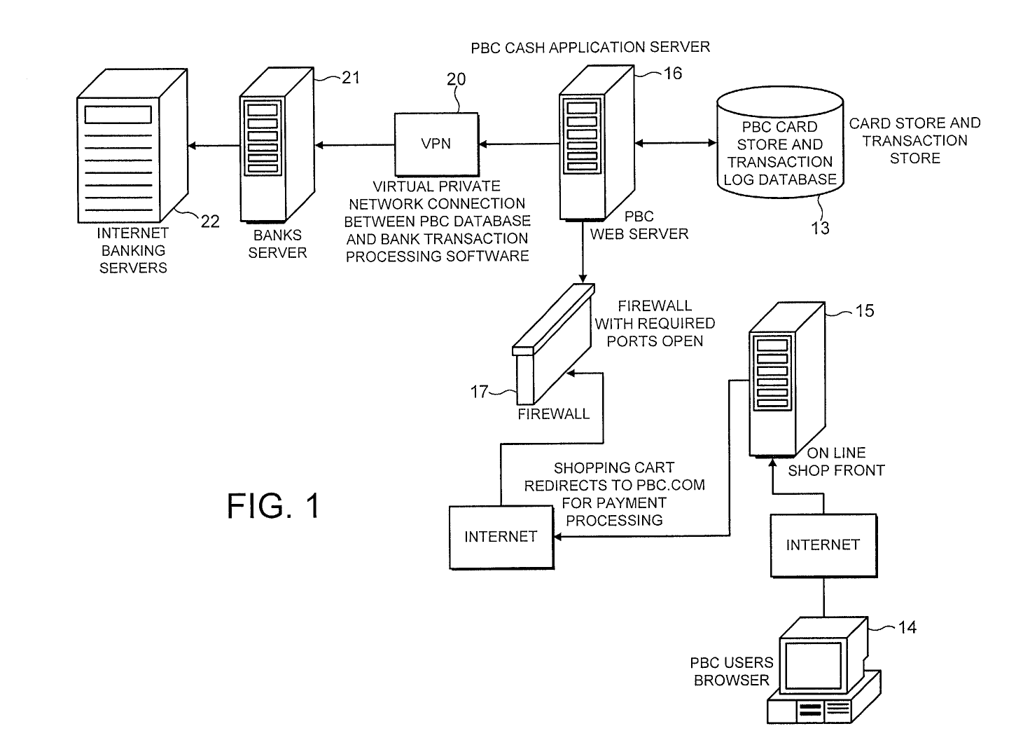

Cards such as card 10 will be generated at printers in batches with numbers being allocated according to a computerised numbering method. Once a batch of cards is generated the printer of the cards will send information regarding the card numbers and the batch numbers of the cards to a computer database of an administrator of the method. Such a computer database is shown at 13 in FIG. 1. Initially when the cards are printed the card numbers (debit identifiers) are noted as inactive in the database 13. The card numbers are not activated until a retailer receives the bundle of cards and communicates (e.g. by telephone) with the administrator to activate the received cards by relaying a bundle number. This is necessary in order to protect the cards against theft occurring between printing and sale at a retail outlet.

The activated cards can be sold to the public by the retailer. A purchaser will buy a card from a retailer, will scratch off the covering layers to reveal the card numbers 11 and 12 and will then use the card to purchase goods and services on-line.

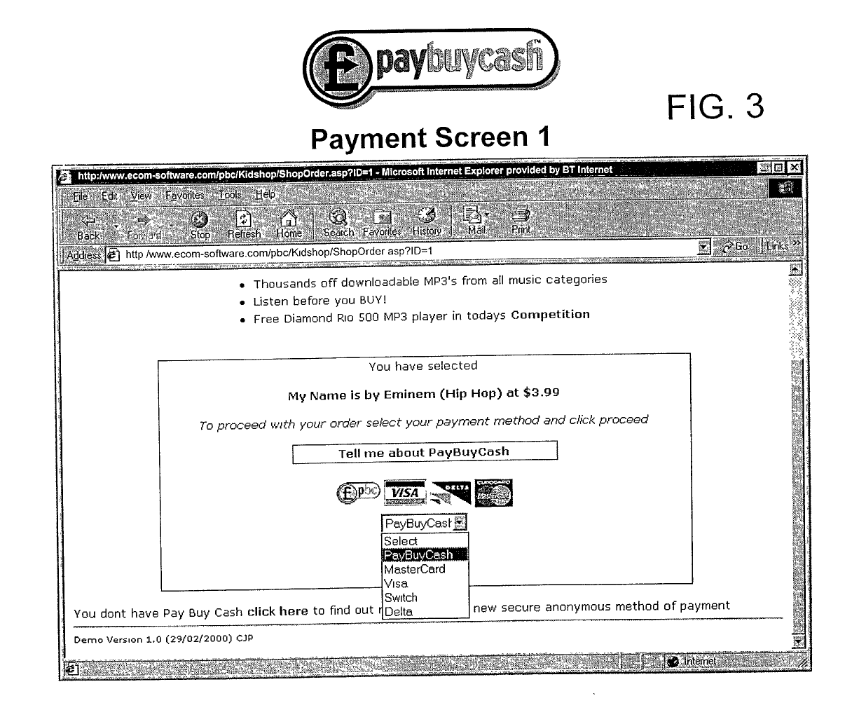

The purchaser will use a standard PERSONAL COMPUTER 14 (see FIG. 1) with web-browser software to access via the Internet a website of an on-line retailer which is hosted on a server 15. The purchaser will purchase advertised goods and services in the usual manner using e.g. a shopping cart program. Once the goods and services for purchase have been selected then the purchaser will be presented with a screen such as the screen illustrated in FIG. 3. The screen offers various payment options including payment by “paybuycash”, the method of the present invention. On selecting the “paybuycash” option the purchaser's personal computer 14 will be redirected to a website hosted on a server 16 of the administrator. The personal computer 14 of the purchaser will be connected via the Internet to the server 16. As shown in FIG. 1, the server 16 will be protected by a firewall 17. This will be described later.

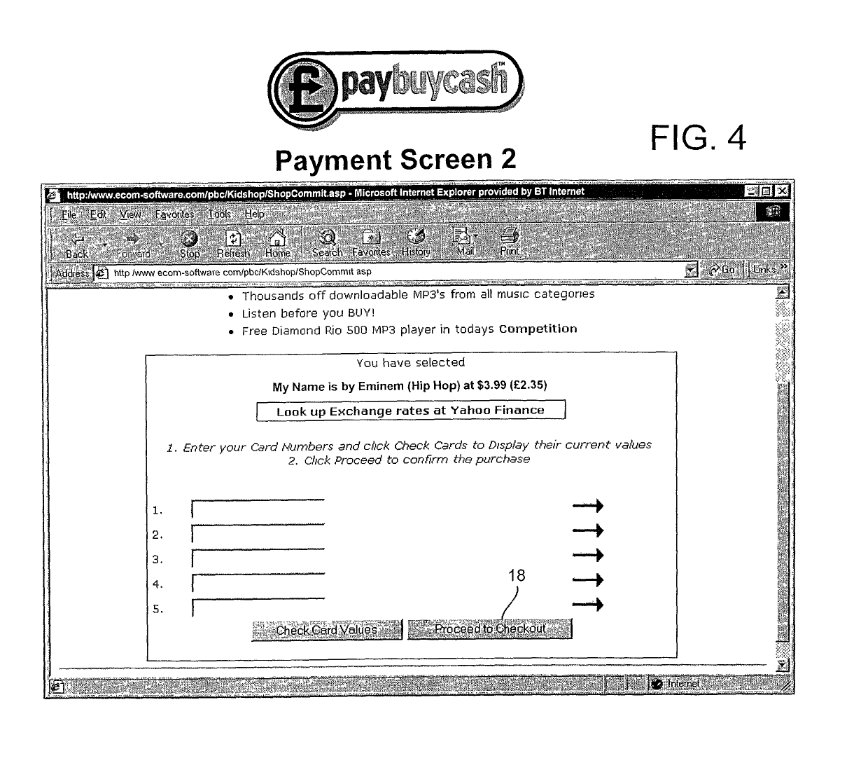

Once the personal computer 14 has been successfully connected via the Internet to the server 16 which serves as payment processing apparatus in the method, then the purchaser will see on the screen of the personal computer 14 a screen such as is shown in FIG. 4. The screen shown in FIG. 4 invites the purchaser to enter the card number 11 and the batch number 12 for the card 10. For each card number 11 the database 13 will hold a stored value account. The stored value account will keep track of the amount available for spending. For example, if a card 10 is bought for the sum of $10.00 then the stored value account in the database 13 will have a starting value of $10.00. Once a purchase of $2.50 is validly made using the card then the stored value recorded in the stored value account associated with the debit identifier on the card will be reduced to $7.50. The value of the stored value account will progressively be reduced to zero. It is envisaged that a stored value account will only remain operative for a set period (e.g., ten years) and will be cancelled at the end of the chosen time period.

If a purchaser does not have in a stored value account relating to a particular debit identifier sufficient funds to purchase goods or services then the purchaser can enter further debit identifiers (e.g. card numbers) until the sum total of the stored value amounts held in the different stored value accounts equals or exceeds the purchase price.

Once the card number or numbers or batch number or numbers have been entered then the purchaser will click on the ‘Proceed’ button 18 to confirm the purchase. At this stage, a validation process is carried out by the server 16.

Initially the batch number 12 is used to obtain details of the batch of cards from which the card 10 originated. The application server 16 checks on the database 13 that the relevant batch has been activated by a retailer.

The batch number 12 is also used to obtain an encryption key for deciphering the card number 11. The encryption keys will be stored in the database 13 in respect of different batch numbers 12.

The card number 11 is encrypted using the correct key and then checked against the an encrypted value which is stored in the database 13 using a private key format.

Once a card has been validated as described above, then the server 16 checks that the stored value account associated with the card number 11 has funds stored which are sufficient to meet the value of the purchase.

If the amount stored in the relevant stored value account or accounts is insufficient, then the purchaser will be invited to enter another card number with its associated batch number via the screen shown in FIG. 4. If the stored value account does have sufficient funds then the purchase price is deducted from the stored value account.

The present method recognises that cards such as the card 10 will be popular with minors, who do not have access to credit cards, but who wish to purchase goods and services on-line using the Internet. This is recognised by colour-coding the cards 10. The cards will be coloured either Red, Green or Yellow. The Green card will be suitable for all ages including children under 16, the Yellow card will be suitable for people over 16, and the Red card will be for adults 18 and over.

For each card number 11 (i.e. debit identifier) a card colour will be noted and for each card colour, a set of permissions will be stored in the database 13.

The method requires classification of each of the websites which accept payment by the method of the invention for the advertised goods and services. For instance, a website advertising for sale childrens' books and games will be suitable for all ages of purchasers. The website will be suitably categorised. When a purchaser uses his personal computer 14 to order goods from the website then during the payment process identification information will be sent from the vendor's website to the payment processing server 16, which will then determine the classification of the website. Either the vendor's website itself will store the classification information which is sent in each transaction, or the identification information will identify a website so that the server 16 can access in the database 13 information regarding classification of the website.

During validation of a card payment the server 16 will determine the colour of the card used in the payment process from the card number 11. This information will be stored in the database 13. Once a card colour has been identified then the payment processing server 16 will know whether goods can be purchased from the vendor's website by all colours of cards or only selected colours. By comparing the colour of the card with the classification of the website the payment processing server 16 will determine whether the transaction can be processed or whether it should be refused.

For instance, if a parent buys for his or her child a Green card 11 and the child then uses a personal computer, e.g. 12, to access a website which has adult material then during the validation process the payment processing server 16 will determine that the card number 11 entered by the child relates to a Green card and that the website is classified such that only Red cards can be used for purchases. Therefore, the payment processing server 16 will refuse to process the payments and will inform the child purchaser accordingly.

The database 13 will have accounts for each vendor subscribing to the method. When a purchaser makes a payment then stored value corresponding to the payment is transferred from the stored value account of the purchaser to the stored value account of the vendor. Periodically payments will be made to the vendor. Such payments will typically be made through a banking network and in FIG. 1 there can be seen a virtual private network 20 which connects the payment processing server 16 to a server 21 of a bank which itself is connected to internal banking servers 22 of the bank. The payment processing server 16 will send instructions via the virtual private network 20 to the bank server 21 to cause the other bank servers 22 to transfer funds to an account of, or nominated by, a vendor.

Once a payment of a purchaser has been accepted then a validation code will be sent by the payment processing server 16 to the website of the vendor, to instruct the vendor to deliver the ordered goods or services.

The payment processing server 16 will log all transactions automatically to ensure that each use of a card can be traced by date, vendor and amount.

In the preferred embodiment each card 10 will have two numbers, the card number 11 and the batch number 12 in order to enhance security and availability of numbers. The two numbers together form a debit identifier.

It is envisaged that the batch number 12 will be an 8 character alphanumeric. The batch number 12 is recorded on the card 10 in clear text. If the database 13 comprises a plurality of different databases (see later) then initially the batch number is used to retrieve the database which holds the related card number. The batch number is secondly used to retrieve a private key and a master key to allow the clear text card number 11 printed on the card to be encrypted. The encrypted card number 11 is then compared with a corresponding stored database entry.

Within each batch of cards produced there will be different card values (in terms of stored value) and colours.

Each card will have a unique card number 11. The encrypted card number will be an encrypted value based on the following data:

1. Date of creation (e.g., 22/03/2000)

2. Initial card value (e.g., 5; 10; 15; 20)

3. Card colour (Red, Yellow, Green)

4. Randomly generated alphanumeric sequence

5. Private key for the batch number

6. Master key for the system.

The values will be encrypted together using a 128 bit hash function. A hash function is an algorithm which can be applied to a hexadecimal string which when using a key will return the secure string. The printed cards themselves will bear a clear text randomly generated 12 character alphanumeric sequence. This gives the possibility of 3612 card numbers for each batch number.

A secure private key is the only way to encrypt the card number 11 to be compared with the encrypted number. Upon entering a valid card number 11 and batch number 12 the processor 16 will (as described above) search its database 13 using the batch number 12 for the key which when applied to the batch will allow correct encryption of the card number 11 and subsequent comparison. This decoding process is shown graphically in FIG. 2.

For the method it is preferred that a secure and scalable hardware and software infrastructure is used. It is preferred that the server 16 is configured to support webfarm configurations. In a webfarm two or more servers are used to host the same website. Multiple servers become necessary when a website attracts a large number of users. HTTP requests are routed to each server in the farm in a round-robin fashion to distribute the load and to allow the payment processing site to handle more requests.

Since the database 13 provides a store of card numbers, information relating to card numbers, information relating to batch numbers and also recorded history of all transactions, it should be scalable easily. The use of clustering technology will support this. In broad terms, a ‘cluster’ is a group of independent systems working together in a single circle. A client machine such as the PERSONAL COMPUTER 14 will interact with a cluster of independent systems as though they were all part of a single server. Cluster configurations are used to address both availability and scalability. In a single system when a cluster fails then the software responds by dispersing the work from the failed system to the remaining systems in the cluster. When the overall load on the systems exceeds the capability of the systems then additional systems may be added to the cluster. Database security will be in force through/during NT security in the hosting domain.

As shown in FIG. 1 a firewall is used. The firewall is a combination of hardware and software that provides a security system to prevent unauthorised access from outside to an internal network or intranet. The firewall prevents direct communication between the network and external computers by routing communication through a proxy server outside of the network. The proxy server determines whether it is safe to let the file pass through to the network. The configuration of the method will typically require two ports open in the firewall; port 80 to support HTTP traffic and port 443 to support HTTPS traffic.

It is preferred that Windows NT4 is used on the server 16 since Windows NT complies with C2 level security requirements through the implementation of the NT file system (NTFS) and its NT directory services (NTDS). The website hosted on the server 16 will use the NTFS file system in order to allow strict policies and ACLs on the website. The server 16 will also use Internet Information Server 4 (IIS) in order to provide anonymity for purchasers. In different situations IIS will pretend to be different users. All processes operating a Windows NT machine are run under a valid Windows NT account. When a program or process (like IIS) is run on behalf of the user, it is said to be running under the security context of the user. The purpose of the security context is to give the process running on behalf of the user no more access to files and resources than users would have if they were running a process locally. When IIS runs on behalf of a user, it is said to be impersonating that user. IIS is designed to handle requests made via the Worldwide Web as an automated service. To do this, IIS needs to run under a valid user security context. The system of the present invention will use anonymous requests allowing any purchaser access to the payment application under the security context of the anonymous user account on the NT server.

The server 16 will also run Microsoft transactions (MTS). This will support and manage transactions through use of the MS DTC service and increases the server performance.

The server 16 will also run the Microsoft Message Q server (MSMSQ) to provide an application to application messaging service.

The database 13 will typically be founded on SQL7, which is a relational database with full transactional and logging support. SQL7 is a high performance scalable enterprise database solution. SQL7 interacts directly with NT and provides integrated security implementing two levels of security in that the NT account must have permission to access the SQL database and that the NT account must be matched to an SQL user account within the database which itself has table-defined permissions.

As mentioned above, the dataflow between the server 16 and the bank will take place across a secure virtual private network (VPN). Details of each vendor will be held in the related database 13 of which one table will hold all transactions which are performed on a vendor's account. The table will pass to the bank to be processed on an agreed regular basis. The vendor will be credited with the total value of all of the transactions. The vendor will also be billed for an agreed percentage of the total value, which will be the payment to the administrator running the server 16.

It is envisaged that the method of the present invention will integrate with shopping cart models typical of on-line retail sites. Shopping cart models allow purchasers to add items for their purchase to their carts and proceed to the checkout when the purchaser is prompted for billing address information, shipping address information and payment details prior to the generation of a receipt and the fulfilment of the order. The model of the present invention works with this by integrating with the shopping cart, prompting the purchaser to use the website hosted on server 16 with the browser software on the personal computer 14 being redirected to the site on the server 16 for subsequent card entry and validation. As mentioned above, as part of this redirection process the website of the vendor will have to pass information to the website hosted on the server 16. This information will be passed typically via a HTTP post query string and will comprise the following:

1. the vendor's ID—a card coded unique identifier identifying each vendor (this being necessary for bank controlled funds transfer);

2. currency code—a hard coded string indicating the currency used for the purchase;

3. total order amount—the total of all items plus value added tax, plus delivery charge;

4. the identification code of a shopping cart, if this is separate from the vendor's website;

5. a return site URL, this URL being that of the online vendor receipt and fulfilment webpage.

In situations where all goods and services offered by a vendor via a website are given the same classification, the vendor's ID will suffice for the payment processing apparatus 16 to retrieve a classification from the database 13. However, when goods and services offered via the same website are classified differently than the above information will have to be supplemented by identification information concerning the ordered goods and/or services When the vendor enters one or more card numbers and one or more batch numbers to cover the shopping value and clicks on the ‘Proceed’ button the above-noted details and the card entry data are posted to the same form, the details noted above being posted to hidden form fields. Then the security validation functions are carried out as described above. A purchaser is informed of any errors and given the opportunity to add additional cards if he or she does not have sufficient stored value on the nominated cards. On completion of the process the website server 16 will redirect the purchaser's browser back to the vendor's website and particularly to the receipt and fulfilment webpage of the website using the return site URL. In this process, a validation code is sent, as described above, indicating a successful or unsuccessful payment. The on-line vendor's shopping cart then deals with the order accordingly either by returning a receipt and fulfilling the order or abandoning the shopping cart contents due to an unsuccessful payment. It is possible that an order could only be partly successful in the case that some ordered goods and/or services have a classification which matches a permission associated with the card number, while others do not. Validation codes could be sent in respect of each ordered good or service to deal with this.

There are several platforms and shopping cart applications in current use across the Internet it is important to note that the integration with the shopping cart can be achieved in different ways.

For websites that take payment methods and pass on to a clearing house a simple HTML script can be integrated into the website to redirect payment details to the website hosted on the server 16.

For websites that redirect purchasers to a third party shopping cart prior to selection of the payment method integration of the present method could be achieved either by changing the shopping cart flow on the original site or by integrating the present method with a shopping cart application run by a third party.

It is envisaged within the method that some sites will advertise for sale goods and services of different classifications. For instance, a site offering the sale of books and videos may offer for sale both childrens' books and videos and also books and videos with adult content. If this is the case then the method and the system must become more sophisticated. The shopping cart purchase system will, in such a case, send to the parent processor 16 identification information identifying the goods and/or services ordered so that the server 16 can ascertain from the database 13 the classification of such goods and services and can determine whether the colour of the card used permits purchase of goods and/or services of such a classification. This can be done either by sending an identification code from the shopping cart application to the website on the server 16 identifying the ordered goods and services (with the classification of such goods and services stored in the database 13) or by sending classification information directly.

It is envisaged that the card used in the method will be sold through a wide variety of retail outlets. It is envisaged that Green and Yellow cards will be sold through Newsagents. Red cards will be sold at licences premises, e.g., at betting shops. In addition, it will be possible to buy debit identifiers having permissions equivalent to those of Green or Yellow cards on-line using credit cards and debit cards. In the latter case, the purchaser will be issued with a card number and a batch number on-line (the numbers together forming a debit identifier) rather than a physical card and validation of the card number will happen automatically.

It is envisaged that the cards will bear advertising.

It is envisaged that the retailers will pay for the batches of received cards at an agreed time after activation, paying an amount for the cards which is less than the amount which the retailers will receive through sale of the cards. It is envisaged that the administrator will make a financial return by taking a percentage of all payments made using the method.

The debit identifier used in the methods described above is an alphanumeric string, but any combinations of symbols would suffice.

The cards described above are distinguished by colour, but could be distinguished from each other in other ways, e.g. shape, size, printing thereon, numbering, lettering, branding, etc.

Whilst above personal computer 14 is used as client computer apparatus by a purchaser of goods and for services, other electronic devices such as mobile telephones could be used.

What is claimed is:

1. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier.

2. A method as claimed in claim 1 wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying each publicly accessible site having regard to the goods/services offered thereby;
the host computer sending to the payment processing means information regarding classification of the publicly accessible site from which the goods/services are ordered; and
the payment processing apparatus determining whether there is permission to order any goods/services from the publicly accessible site of the vendor.

3. A method as claimed in claim 1 wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying every good and/or service offered for sale by a vendor on a publicly accessible site;
the host computer sending to the payment processing means classification information regarding individual ordered goods and/or services; and
the payment processing apparatus determining from the stored permission information for individual ordered goods and/or services whether there is permission to order such goods and/or services.

4. A method as claimed in claim 2, comprising the steps of:
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier.

5. A method as claimed in claim 4 wherein:
the debit identifier borne by the card is covered by a removable layer and the method comprises the step of the purchaser removing the removable layer to reveal the debit identifier.

6. A method as claimed in claim 4 wherein:
the retailer purchases from the administrator batches of cards bearing debit identifiers;
the retailer communicates with the administrator to confirm receipt of each batch of cards; and
the administrator activates a debit identifier only after receiving confirmation of receipt by the retailer of a card associated with the debit identifier, the administrator refusing to authorise debiting of a stored value account until the debit identifier associated therewith has been activated.

7. A method as claimed in claim 4 wherein:
each card has indicator means indicating which classifications of goods and services can be purchased using the card; and
the purchaser selects a card for purchase having regard to the indicator means.

8. A method as claimed in claim 7 wherein the indicator means comprises the colour of the card and the purchaser selects a card for purchase having regard to the colour thereof.

9. A method as claimed in claim 7 wherein:
the retailer will sell cards with certain indicator means only to purchasers above an age threshold.

10. A method as claimed in claim 4 wherein:
each card when purchased has a debit identifier which has associated therewith a stored value account containing a predetermined level of stored value ascertainable by a purchaser prior to purchase; and
different cards bear debit identifiers associated with stored value accounts of different values.

11. Use of a personal computer as client computer apparatus in a method according to claim 1.

12. Use of a computer server as host computer apparatus in a method according to claim 1.

13. Use of a computer server as payment processing apparatus in a method according to claim 1.

14. Use of a card bearing a debit identifier in a method according to claim 1.

15. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier;
wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying every good and/or service offered for sale by a vendor on a publicly accessible site;
the host computer sending to the payment processing means classification information regarding individual ordered goods and/or services;
the payment processing apparatus determining from the stored permission information for individual ordered goods and/or services whether there is permission to order such goods and/or services;
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier.

16. A method as claimed in claim 15 wherein:
the debit identifier borne by the card is covered by a removable layer and the method comprises the step of the purchaser removing the removable layer to reveal the debit identifier.

17. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier;
wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying each publicly accessible site having regard to the goods/services offered thereby;
the host computer sending to the payment processing means information regarding classification of the publicly accessible site from which the goods/services are ordered;
the payment processing apparatus determining whether there is permission to order any goods/services from the publicly accessible site of the vendor;
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier;
wherein the debit identifier borne by the card is covered by a removable layer and the method comprises the step of the purchaser removing the removable layer to reveal the debit identifier;
the retailer purchases from the administrator batches of cards bearing debit identifiers;
the retailer communicates with the administrator to confirm receipt of each batch of cards; and
the administrator activates a debit identifier only after receiving confirmation of receipt by the retailer of a card associated with the debit identifier, the administrator refusing to authorise debiting of a stored value account until the debit identifier associated therewith has been activated.

18. A method as claimed in claim 17 wherein:
the retailer purchases from the administrator batches of cards bearing debit identifiers;
the retailer communicates with the administrator to confirm receipt of each batch of cards; and
the administrator activates a debit identifier only after receiving confirmation of receipt by the retailer of a card associated with the debit identifier, the administrator refusing to authorise debiting of a stored value account until the debit identifier associated therewith has been activated.

19. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier;
wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying each publicly accessible site having regard to the goods/services offered thereby;
the host computer sending to the payment processing means information regarding classification of the publicly accessible site from which the goods/services are ordered;
the payment processing apparatus determining whether there is permission to order any goods/services from the publicly accessible site of the vendor;
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier;
wherein the debit identifier borne by the card is covered by a removable layer and the method comprises the step of the purchaser removing the removable layer to reveal the debit identifier;
each card has indicator means indicating which classifications of goods and services can be purchased using the card; and
the purchaser selects a card for purchase having regard to the indicator means.

20. A method as claimed in claim 19 wherein the indicator means comprises the colour of the card and the purchaser selects a card for purchase having regard to the colour thereof.

21. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier;
wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying each publicly accessible site having regard to the goods/services offered thereby;
the host computer sending to the payment processing means information regarding classification of the publicly accessible site from which the goods/services are ordered;
the payment processing apparatus determining whether there is permission to order any goods/services from the publicly accessible site of the vendor;
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier;
the retailer purchases from the administrator batches of cards bearing debit identifiers;
the retailer communicates with the administrator to confirm receipt of each batch of cards;
the administrator activates a debit identifier only after receiving confirmation of receipt by the retailer of a card associated with the debit identifier, the administrator refusing to authorise debiting of a stored value account until the debit identifier associated therewith has been activated;
each card has indicator means indicating which classifications of goods and services can be purchased using the card; and
the purchaser selects a card for purchase having regard to the indicator means.

22. A method as claimed in claim 21 wherein the indicator means comprises the colour of the card and the purchaser selects a card for purchase having regard to the colour thereof.

23. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier;
wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying each publicly accessible site having regard to the goods/services offered thereby;
the host computer sending to the payment processing means information regarding classification of the publicly accessible site from which the goods/services are ordered;
the payment processing apparatus determining whether there is permission to order any goods/services from the publicly accessible site of the vendor;
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier;
each card has indicator means indicating which classifications of goods and services can be purchased using the card;
the purchaser selects a card for purchase having regard to the indicator means;
wherein the indicator means comprises the colour of the card and the purchaser selects a card for purchase having regard to the colour thereof; and
wherein the retailer will sell cards with certain indicator means only to purchasers above an age threshold.

24. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier;
wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying each publicly accessible site having regard to the goods/services offered thereby;
the host computer sending to the payment processing means information regarding classification of the publicly accessible site from which the goods/services are ordered;
the payment processing apparatus determining whether there is permission to order any goods/services from the publicly accessible site of the vendor;
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier;
wherein the debit identifier borne by the card is covered by a removable layer and the method comprises the step of the purchaser removing the removable layer to reveal the debit identifier;
wherein each card when purchased has a debit identifier which has associated therewith a stored value account containing a predetermined level of stored value ascertainable by a purchaser prior to purchase; and
different cards bear debit identifiers associated with stored value accounts of different values.

25. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier;
wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying each publicly accessible site having regard to the goods/services offered thereby;
the host computer sending to the payment processing means information regarding classification of the publicly accessible site from which the goods/services are ordered;
the payment processing apparatus determining whether there is permission to order any goods/services from the publicly accessible site of the vendor;
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier;
the retailer purchases from the administrator batches of cards bearing debit identifiers;
the retailer communicates with the administrator to confirm receipt of each batch of cards;
the administrator activates a debit identifier only after receiving confirmation of receipt by the retailer of a card associated with the debit identifier, the administrator refusing to authorise debiting of a stored value account until the debit identifier associated therewith has been activated;
wherein each card when purchased has a debit identifier which has associated therewith a stored value account containing a predetermined level of stored value ascertainable by a purchaser prior to purchase; and
different cards bear debit identifiers associated with stored value accounts of different values.

26. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier;
wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying each publicly accessible site having regard to the goods/services offered thereby;
the host computer sending to the payment processing means information regarding classification of the publicly accessible site from which the goods/services are ordered;
the payment processing apparatus determining whether there is permission to order any goods/services from the publicly accessible site of the vendor;
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier;
each card has indicator means indicating which classifications of goods and services can be purchased using the card;
the purchaser selects a card for purchase having regard to the indicator means;
wherein each card when purchased has a debit identifier which has associated therewith a stored value account containing a predetermined level of stored value ascertainable by a purchaser prior to purchase; and
different cards bear debit identifiers associated with stored value accounts of different values.

27. A method of conducting transactions using a distributed computer network such as the Internet, the method comprising:
a purchaser of goods and/or services using client computer apparatus to access via a telecommunications network host computer apparatus which hosts a publicly accessible site of a vendor which advertises for sale goods and/or services;
the purchaser using the client computer apparatus to send electronically via the telecommunications network to the host apparatus an order for advertised goods and/or services;
the host computer linking the client computer apparatus via the telecommunications network with payment processing apparatus;
a payment administrator storing in a database of the payment processing apparatus records of a plurality of debit identifiers and a plurality of stored value accounts, each debit identifier being linked with a single stored value account;
the purchaser using the client computer apparatus to send to the payment processing apparatus a debit identifier with authorisation to debit from the stored value account associated with the debit identifier a sum for purchase of the ordered goods and/or services; and
the payment processing apparatus after receipt of the debit identifier debiting the stored value account linked thereto and transferring electronically payment for the ordered goods and services to an account of or nominated by the vendor;
characterised in that:
the host computer apparatus sends to the payment processing apparatus identification information from which the payment processing apparatus can determine a classification of the ordered goods and/or services;
the payment processing apparatus stores for each debit identifier permission information detailing which classifications of goods and/or services can be purchased; and
the payment processing apparatus accepts an authorisation to debit value from the stored value account associated with the debit identifier only when the identification information received from the host computer indicates that the ordered goods and/or services have a classification which matches a classification in the permission information stored for the debit identifier;
wherein a plurality of vendors advertise for sale goods and/or services via a plurality of sites hosted on a plurality of host computer apparatus all connected to the telecommunications network and wherein a plurality of purchasers use a plurality of client computer apparatus to access the telecommunications network and to send orders for goods and/or services via the telecommunications network to the plurality of host apparatus, the method additionally comprising the steps of:
classifying each publicly accessible site having regard to the goods/services offered thereby;
the host computer sending to the payment processing means information regarding classification of the publicly accessible site from which the goods/services are ordered;
the payment processing apparatus determining whether there is permission to order any goods/services from the publicly accessible site of the vendor;
a purchaser purchasing from a retailer a card bearing a debit identifier;
the retailer collecting payment for the card from the purchaser; and
the purchaser subsequently using the debit identifier on the purchased card to authorise debiting from the stored value account associated with the debit identifier;
each card has indicator means indicating which classifications of goods and services can be purchased using the card;
the purchaser selects a card for purchase having regard to the indicator means;
wherein the indicator means comprises the colour of the card and the purchaser selects a card for purchase having regard to the colour thereof;
wherein each card when purchased has a debit identifier which has associated therewith a stored value account containing a predetermined level of stored value ascertainable by a purchaser prior to purchase; and
different cards bear debit identifiers associated with stored value accounts of different values.
